(19) United States
(12) Patent Application Publication
(10) Pub. No.: US 2025/0125731 A1
(43) Pub. Date: Apr. 17, 2025

(54) SEMICONDUCTOR DEVICE, CURRENT RESONANT POWER SUPPLY AND CONTROL METHOD THEREOF

(71) Applicants: Sanken Electric Co., Ltd., Saitama-ken (JP); SANKEN ELECTRIC KOREA CO.,LTD., Seoul (KR)

(72) Inventors: Koichi ITO, Seoul (KR); Eun Suk LEE, Seoul (KR); Hanju KANG, Saitama-ken (JP)

(73) Assignees: Sanken Electric Co., Ltd., Saitama-ken (JP); SANKEN ELECTRIC KOREA CO.,LTD., Seoul (KR)

(21) Appl. No.: 18/827,893

(22) Filed: Sep. 9, 2024

(30) Foreign Application Priority Data
Oct. 16, 2023 (CN) 202311343658.8

(51) Int. Cl. H02M 3/335; H02M 1/00

(52) U.S. Cl. CPC H02M 3/33507; H02M 1/0009; H02M 1/0035

(57) ABSTRACT

A semiconductor device used to control a current resonant power supply includes: a load detection circuit detecting a load state of the current resonant power supply; a frequency setting signal generation circuit generating first and second signals according to a feedback signal changing oppositely to an output signal of the current resonant power supply during a light load state and generating a frequency setting signal according to the first and second signals, and the first signal is a signal obtained by multiplying the feedback signal by a value N; a burst oscillation circuit generating a burst oscillation start signal according to the frequency setting signal; a switch control circuit generating a signal driving a first switching element and a second switching element connected in series with the current resonant power supply to turn on and off alternately according to the frequency setting signal and the burst oscillation start signal.

### CROSS-REFERENCE TO RELATED APPLICATION

This application claims the priority benefit of China application serial no. 202311343658.8, filed on Oct. 16, 2023. The entirety of the above-mentioned patent application is hereby incorporated by reference herein and made a part of this specification.

### BACKGROUND

### Technical Field

Embodiments of the disclosure relate to the semiconductor field, and particularly relates to a semiconductor device, a current resonant power supply, and a control method thereof.

### Description of Related Art

In order to maintain the efficiency of the current resonant power supply device at a light load, when the load state is a light load, the current resonant power supply device may be controlled to operate in a burst oscillation mode, so as to reduce the loss in the circuit. At this time, in order to suppress the rapid change of the drain current of the switching element in the current resonant power supply device, it is necessary to control burst oscillation and the burst oscillation cycle at an appropriate frequency.

It should be noted that the above introduction to the technical background is only for the convenience of providing a clear and complete description of the technical solution of the disclosure and for the convenience of understanding by persons skilled in the art, it cannot be considered that the above technical solutions are well known to persons skilled in the art simply because these solutions are explained in the background technology part of this disclosure.

### SUMMARY

The inventors have discovered that the frequency of the burst oscillation mode can be set according to the voltage of a specific end. For example, in the patent document with publication number JP2016052161A, the frequency of the burst oscillation mode is set according to the voltage V_{SB} of a dedicated SB end. However, in this manner, the switching times of the switching element of the current resonant power supply device are more frequent, and there is reactive power on the primary side of the current resonant power supply device that is not sent to the secondary side, so the loss is large; at the same time, the output overshoot (ripple) of the current resonant power supply device is also large.

In the patent document with publication number JP2016111758A, the frequency of the burst oscillation mode is set according to a lower signal of the voltage V_{CS} of the CS end and the voltage V_{FB} of the FB end of the control IC. However, in this manner, since the signal at the FB end is set with an external phase compensation constant in a manner that optimizes the operation during stable operation, it is difficult to adjust the burst operation in a manner that does not affect the operation during stable operation (for example, adjustment of the switching frequency, burst cycle, noise).

In view of at least one of the above problems, embodiments of the disclosure provide a semiconductor device, a current resonant power supply, and a control method thereof to reduce power consumption in a light load state.

According to the first aspect of an embodiment of the disclosure, a semiconductor device is provided. The semiconductor device is used to control a current resonant power supply, the current resonant power supply includes a first switching element and a second switching element connected in series between an output end and a grounding end of an AC power source, and the semiconductor device includes:

A load detection circuit is used to detect the load state of the current resonant power supply.

When the load detection circuit detects the load state being a light load state, a frequency setting signal generation circuit generates a first signal and a second signal according to a feedback signal changing oppositely to an output signal of the current resonant power supply and generates a frequency setting signal according to the first signal and the second signal; the first signal is a signal obtained by multiplying the feedback signal by a value N, the second signal is a signal that increasing when the feedback signal is greater than a preset first threshold and decreasing when the feedback signal is less than a preset second threshold, and the frequency setting signal is the smaller signal of the first signal and the second signal.

A burst oscillation circuit generates a burst oscillation start signal causing the first switching element and the second switching element to perform burst oscillation according to the frequency setting signal.

A switch control circuit generates a driving signal according to the frequency setting signal and the burst oscillation start signal to alternately turn the first switching element and the second switching element on and off.

According to the second aspect of an embodiment of the disclosure, a control method of a current resonant power supply is provided, in which the current resonant power supply includes a first switching element and a second switching element connected in series between an output end and a grounding end of an AC power source, and the method includes:

A load state of the current resonant power supply is detected.

When the load state is detected as a light load state, a first signal and a second signal are generated according to a feedback signal changing oppositely to the output signal of the current resonant power supply and a frequency setting signal is generated according to the first signal and the second signal; in which the first signal is a signal obtained by multiplying the feedback signal by a value N, the second signal increasing when the feedback signal is greater than a preset first threshold and decreasing when the feedback signal is less than a preset second threshold, and the frequency setting signal is the smaller signal of the first signal and the second signal.

A burst oscillation start signal causing the first switching element and the second switching element to perform burst oscillation is generated according to the frequency setting signal.

A driving signal is generated according to the frequency setting signal and the burst oscillation start signal to alternately turn the first switching element and the second switching element on and off.

According to the third aspect of an embodiment of the disclosure, a current resonant power supply is provided, the current resonant power supply includes:

The first switching element and the second switching element are connected in series between the output end and the grounding end of the AC power source.

A series circuit is disposed between a connection end and a grounding end of the first switching element and the second switching element.

As described in the first aspect of the disclosure, the semiconductor device controls the first switching element and the second switching element.

One of the beneficial effects of the embodiment of the disclosure is that the smaller signal of the N-multiplied feedback signal and the voltage signal of the internal end generated based on the feedback signal is used to set the frequency, the value of N may be changed according to the load demand, thereby the activation and deactivation time of the burst oscillation mode of the current resonant power supply may be adjusted to reduce reactive power and reduce losses.

With reference to the following description and the accompanying drawings, specific embodiments of the disclosure are disclosed in detail, indicating the manner in which the principles of the disclosure may be employed. It should be understood that the embodiments of the disclosure are not limited in scope thereby. The embodiments of the disclosure include numerous changes, modifications, and equivalents within the spirit and scope of the appended claims.

Features described and/or illustrated with respect to one embodiment may be used in the same or similar manner in one or more other embodiments, combined with features in other embodiments, or substituted for features in other embodiments.

It should be emphasized that the term “include/comprises” when used herein refers to the presence of features, integers, steps, or components, but does not exclude the presence or addition of one or more other features, integers, steps, or components.

### BRIEF DESCRIPTION OF THE DRAWINGS

Elements and features described in one drawing or one implementation according to embodiments of the disclosure may be combined with elements and features shown in one or more other drawings or implementations. Furthermore, in the drawings, similar reference numerals refer to corresponding parts throughout the drawings and may be used to indicate corresponding parts used in more than one embodiment.

FIG. 1 is a schematic diagram of a semiconductor device according to an embodiment of the disclosure.

FIG. 2 is a schematic diagram of a current resonant power supply according to an embodiment of the disclosure.

FIG. 3 is a schematic diagram of a circuit structure of the semiconductor device according to an embodiment of the disclosure.

FIG. 4 is another schematic diagram of the circuit structure of the semiconductor device according to an embodiment of the disclosure.

FIG. 5 is a signal timing diagram according to an embodiment of the disclosure.

FIG. 6 is another signal timing diagram according to an embodiment of the disclosure.

FIG. 7 is a schematic diagram of a control method for the current resonant power supply according to an embodiment of the disclosure.

### DESCRIPTION OF THE EMBODIMENTS

The foregoing and other features of the disclosure will be clearly described through the following description with reference to the accompanying drawings. In the specification and drawings, specific embodiments of the disclosure are disclosed in detail, the embodiments illustrate some examples in which the principles of the disclosure may be adopted. It should be understood that the disclosure is not limited to the described embodiments, rather, the disclosure includes all modifications, variations, and equivalents falling within the scope of the appended claims.

In the embodiments of the disclosure, the terms, for example, “first” and “second”, are used to distinguish between different elements for identification purposes and do not indicate, for example, the spatial arrangement or time sequence of the elements. Therefore, the elements are not be limited by the terms. The term “and/or” includes any and all combinations of one or more of the associated listed items. The terms “comprising”, “including”, “having” and the like refer to the presence of stated features, elements, components, or members, but do not preclude the presence or addition of one or more other features, elements, components, or members.

In the embodiments of the disclosure, the singular forms, for example, “a” and “the”, include plural forms and should be broadly understood as “a kind” or “a type” rather than being limited to the meaning of “one”; in addition, the term “the” should be understood to include both the singular and the plural forms, unless the context clearly indicates otherwise. Additionally, the term “according to” should be understood as “at least partially according to . . . ” and the term “based on” should be understood as “at least partially based on . . . ” unless the context clearly indicates otherwise.

In the embodiments of the disclosure, it should be noted that, unless otherwise clearly specified and limited, the term “connection” should be understood in a broad sense, for example, it may be a fixed connection, a detachable connection, or an integral connection; it may be a mechanical connection or an electrical connection; the connection may be direct or indirect via an intermediate medium/component. For persons skilled in the art, the specific meanings of the above terms in this disclosure may be understood based on specific circumstances.

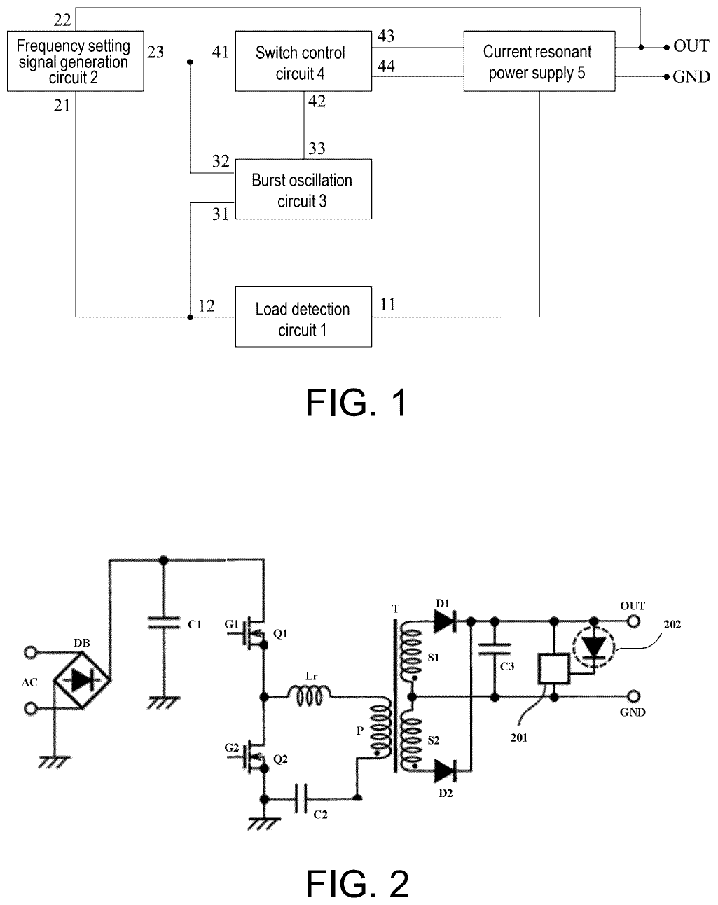

The disclosure provides a semiconductor device configured to control a current resonant power supply. The semiconductor device may be a structure in which all components are integrated on the same semiconductor chip, or a structure in which some components are integrated on the same semiconductor chip and the non-integrated components are connected to the semiconductor chip through specific ends, and the disclosure is not limited thereto. FIG. 1 is a schematic diagram of a semiconductor device according to an embodiment of the disclosure. As shown in FIG. 1, the semiconductor device includes a load detection circuit 1, a frequency setting signal generation circuit 2, a burst oscillation circuit 3, and a switch control circuit 4, in which the switch control circuit 4 is used to control a current resonant power supply 5.

In order to facilitate the description of the semiconductor device of the disclosure, a current resonant power supply is first provided herein, as shown in FIG. 2 and the related description thereof. The subsequent embodiments of the disclosure will be described by taking the controlling of the current resonant power supply shown in FIG. 2 as an example. It should be noted that the semiconductor device of the disclosure is not limited to controlling the current resonant power supply of the structure shown in FIG. 2, but is also applicable to controlling current resonant power supplies including more or fewer components.

FIG. 2 is a schematic diagram of a current resonant power supply according to an embodiment of the disclosure. As shown in FIG. 2, the current resonant power supply 5 includes an AC power source AC, a full-wave rectifier circuit DB, a first switching element Q1, a second switching element Q2, a transformer T, an inductor Lr, capacitors C1-C3, and diodes D1-D2. In the operation, the full-wave rectifier circuit DB performs full-wave rectification on the AC voltage output by the AC power source AC, and the full-wave rectified voltage is output via the capacitor C1 to the first switching element Q1 and the second switching element Q2 connected in series between output ends of the AC power source AC/the full-wave rectifier circuit DB and a grounding end GND. The first switching element Q1 and the second switching element Q2 are formed by switching elements such as MOSFET, for example, N-channel MOSFET, P-channel MOSFET. Also, the turn-on conditions of the first switching element Q1 and the second switching element Q2 are the same, for example, both are turned on at a high level, or both are turned on at a low level. The first switching element Q1 and the second switching element Q2 shown in FIG. 2 are both N-channel MOSFETs turned on at a high level, but the disclosure is not limited thereto.

Between the connection points of the first switching element Q1 and the second switching element Q2, for example, between the first electrode (for example, source) of the first switching element Q1 and the second electrode (for example, drain) of the second switching element Q2 as shown in FIG. 2, a series circuit including the inductor Lr for current resonance, a primary winding P of the transformer T, and the capacitor C2 for current resonance is connected. The transformer T further includes two secondary windings S1 and S2 connected in series, in which the first end of the secondary winding S1 is connected to the anode of a diode D1, and the second end is connected to the second end of the secondary winding S2 and is also connected to the grounding end GND; the first end of the secondary winding S2 is connected to the anode of a diode D2. The cathode of the diode D1 and the cathode of the diode D2 are connected to the first end of the capacitor C3 and serve as an output end OUT of the current resonant power supply 5, and the second end of the capacitor C3 is connected to the grounding end GND.

The semiconductor device of the disclosure is used to, in a light load state, control the first switching element Q1 and the second switching element Q2 of the current resonant power supply 5 to perform a switching operation in a burst oscillation mode according to a set frequency, that is, an operation of “alternately turning on and off” in the burst oscillation mode.

For example, referring to FIG. 1 and FIG. 2, an input end 11 of the load detection circuit 1 is connected to an end of the primary winding P of the transformer T in the current resonant power supply 5, and an output end 12 thereof is connected to the frequency setting signal generation circuit 2. When the current resonant power supply 5 is in operation, the current flowing through the primary winding P includes the circulating current (the current not sent to the secondary winding of the transformer T) and the load current (the current proportional to the output current of the output end OUT). The load detection circuit 1 extracts the load current from the primary winding P, detects the load state according to the load current, and outputs a signal corresponding to the load state through the output end 12 thereof. In the operation, the load state includes a light load state and a heavy load state. In subsequent embodiments, the disclosure will describe the controlling of the semiconductor device to the current resonant power supply 5 in the light load state. The controlling in the heavy load state may be implemented with reference to the related art and will not be described in detail in the disclosure.

A first input end 21 of the frequency setting signal generation circuit 2 is connected to the output end 12 of the load detection circuit 1 and receives the signal corresponding to the load state output by the load detection circuit 1; a second input end 22 is connected to the output end OUT of the current resonant power supply 5 and receives the output signal of the current resonant power supply 5. When the load detection circuit 1 detects that the load state is a light load state and outputs a signal corresponding to the light load state to the frequency setting signal, the frequency setting signal generation circuit 2 generates a feedback signal changing oppositely to the output signal according to the output signal of the output end OUT of the current resonant power supply 5, generates a first signal and a second signal according to the feedback signal, and generates a frequency setting signal in the light load state according to the first signal and the second signal. Specifically, the smaller signal of the first signal and the second signal is used as the frequency setting signal in the light load state, and the frequency setting signal is output through an output end 23 thereof. In the operation, the first signal is a signal obtained by multiplying the feedback signal by a value N, and the second signal is a signal increasing when the feedback signal is greater than a preset first threshold and decreasing when the feedback signal is less than a preset second threshold.

When the load detection circuit 1 detects that the load state is a heavy load state and outputs a signal corresponding to the heavy load state to the frequency setting signal, the frequency setting signal generation circuit 2 generates a feedback signal changing oppositely to the output signal according to the output signal of the output end OUT of the current resonant power supply 5, and uses the feedback signal as the frequency setting signal in the heavy load state. The controlling in the heavy load state is not described in detail in the disclosure.

A first input end 31 of the burst oscillation circuit 3 is connected to the output end 12 of the load detection circuit 1 and receives a signal corresponding to the load state output by the load detection circuit 1; a second input end 32 is connected to the output end 23 of the frequency setting signal generation circuit 2 and receives the frequency setting signal. When the signal corresponding to the load state output by the load detection circuit 1 is a signal corresponding to the light load state, the burst oscillation circuit 3 generates a burst oscillation start signal causing the first switching element Q1 and the second switching element Q2 of the current resonant power supply 5 to perform burst oscillation according to the frequency setting signal.

A first input end 41 of the switch control circuit 4 is connected to the output end 23 of the frequency setting signal generation circuit 2 and used to receive the frequency setting signal, a second input end 42 thereof is connected to an output end 33 of the burst oscillation circuit 3 and used to receive the burst oscillation start signal in the light load state, a first output end 43 thereof is connected to a gate G1 of the first switching element Q1 of the current resonant power supply 5, and a second output end 44 thereof is connected to a gate G2 of the second switching element Q2 of the current resonant power supply 5. When the load detection circuit 1 detects the light load state, the switch control circuit 4 generates a driving signal according to the frequency setting signal in the light load state output by the frequency setting signal generation circuit 2 and the burst oscillation start signal in the light load state output by the burst oscillation circuit 3, and the driving signal controls the first switching element Q1 and the second switching element Q2 of the current resonant power supply 5 to turn on and off alternately according to a set frequency (that is, the frequency of the frequency setting signal). In the operation, the driving signal includes a first driving signal and a second driving signal with opposite levels, the first driving signal is used to control the first switching element Q1, and the second driving signal is used to control the second switching element Q2. When the first driving signal controls the first switching element Q1 to turn on, since the turn-on conditions of the first switching element Q1 and the second switching element Q2 are the same and the level of the second driving signal is opposite to the first driving signal, the second driving signal controls the second switching element Q2 to turn off. In contrast, when the first driving signal controls first switching element Q1 to turn off, the second driving signal controls the second switching element Q2 to turn on.

It is worth noting that the above FIG. 1 and FIG. 2 only schematically illustrate the semiconductor device of an embodiment of the disclosure, but the disclosure is not limited thereto. For example, the connection relationship between the modules or components may be appropriately adjusted, and other modules or components may be added, or some modules or components may be reduced. Persons skilled in the art may make appropriate modifications based on the above content, and are not limited to the description of FIG. 1 and FIG. 2 above.

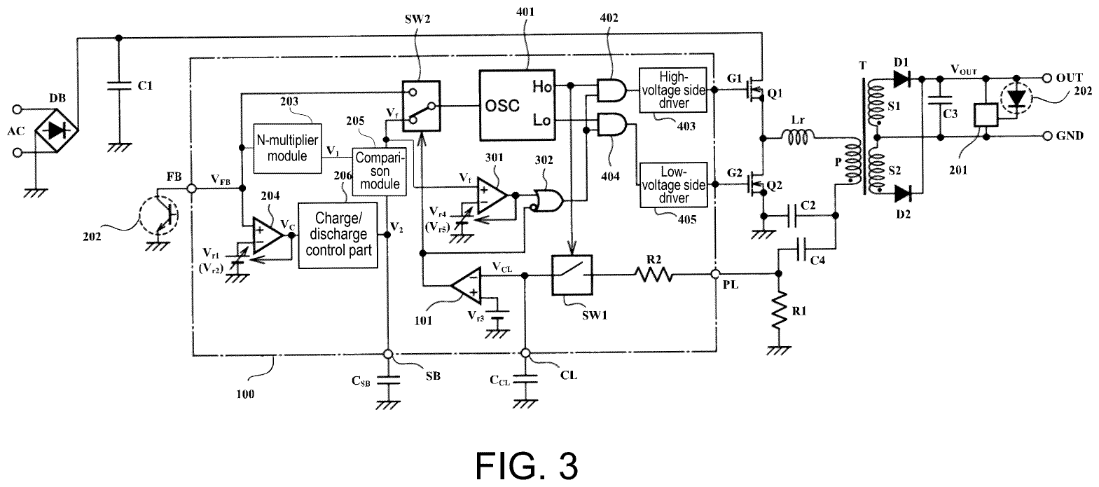

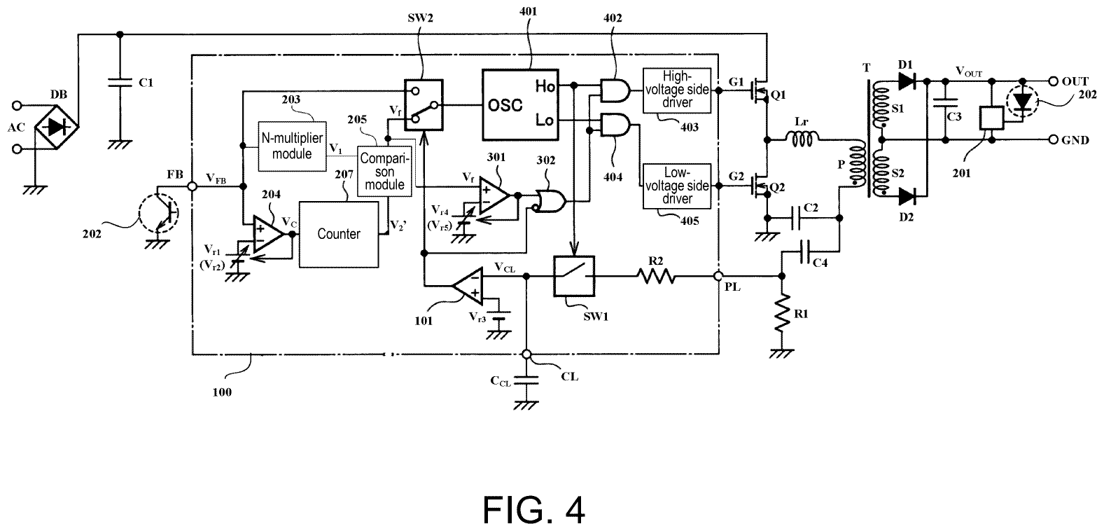

Each circuit in the semiconductor device will be described in detail below. FIG. 3 is a schematic diagram of a circuit structure of the semiconductor device according to an embodiment of the disclosure, and FIG. 4 is another schematic diagram of the circuit structure of the semiconductor device according to an embodiment of the disclosure. FIG. 3 and FIG. 4 both exemplarily show the specific circuit structures of the load detection circuit 1, the frequency setting signal generation circuit 2, the burst oscillation circuit 3, the switch control circuit 4, and the current resonant power supply 5. Furthermore, the load detection circuit 1, the burst oscillation circuit 3, the switch control circuit 4, and the current resonant power supply 5 in FIG. 3 and FIG. 4 are exactly the same, only part of the structure of the frequency setting signal generation circuit 2 is different, and the specific differences will be described in the subsequent embodiments. The current resonant power supply 5 in FIG. 3 and FIG. 4 has the same structure as shown in FIG. 2. For related descriptions, reference may be made to the description above, so details will not be repeated here.

As shown in FIG. 3 and FIG. 4, the frequency setting signal generation circuit 2 includes a feedback circuit, an N-multiplier circuit, a first comparison circuit, a signal generation circuit, and a second comparison circuit.

The feedback circuit includes a voltage detector 201 and a photoelectric coupler 202. In the operation, the voltage detector 201 detects the voltage across the capacitor C3 of the current resonant power supply 5, that is, an output voltage V_{OUT} of the current resonant power supply 5, and outputs the detected output voltage to an FB end of the frequency setting signal generation circuit 2 through the photoelectric coupler 202. The photoelectric coupler 202 is used to generate a feedback signal V_{FB} changing oppositely to the output signal according to the output signal of the current resonant power supply 5. Herein, changing oppositely means, for example: when the output signal increases, the feedback signal decreases; when the output signal decreases, the feedback signal increases. Specifically, the details will be explained in subsequent examples.

The N-multiplier circuit is used to multiply the feedback signal V_{FB} by a value N set in the N-multiplier circuit to obtain a first signal V₁, that is, V₁=V_{FB}*N. In FIG. 3 and FIG. 4, the N-multiplier circuit includes an N-multiplier module 203 connected to the FB end. The value N set in the N-multiplier circuit is a positive number greater than 1. In practical applications, N may be adjusted accordingly within the value range as needed.

The first comparison circuit is used to generate a control signal V_{C} according to the feedback signal V_{FB}, the preset first threshold Vᵣ₁, and the preset second threshold Vᵣ₂. In FIG. 3 and FIG. 4, the first comparison circuit includes a first comparator 204, which is a non-inverting comparator with a variable threshold. The non-inverting input end of the first comparator 204 is connected to the FB end, and the inverting input end is input with the preset first threshold Vᵣ₁ or the second threshold Vᵣ₂.

The signal generation circuit is used to generate a second signal V₂ according to the control signal V_{C}.

The second comparison circuit is used to compare the magnitudes of the first signal V₁ and the second signal V₂ and output the smaller signal of the first signal V₁ and the second signal V₂ as the frequency setting signal V_{f}. In FIG. 3 and FIG. 4, the second comparison circuit is a comparison module 205.

The structure of the signal generation circuit is different between FIG. 3 and FIG. 4. For example, in FIG. 3, the signal generation circuit includes a charge and discharge control part 206 and a first capacitor C_{SB}. In the operation, the input end of the charge and discharge control part 206 is connected to the output end of the first comparison circuit, that is, the output end of the first comparator 204, and is activated or deactivated according to the control signal V_{C}; an end of the first capacitor C_{SB} is connected to the output end of the charge and discharge control part 206 and an input end of the second comparison circuit, that is, the comparison module 205; the other end is connected to the grounding end, and outputs the second signal V₂ to the comparison module 205. When the feedback signal V_{FB} is greater than the first threshold Vᵣ₁, the charge and discharge control part 206 is activated, the first capacitor C_{SB} is charged, the second signal V₂ increases, and the threshold of the first comparator 204 is changed to the second threshold Vᵣ₂; when the feedback signal V_{FB} is less than the second threshold Vᵣ₂, the charge and discharge control part 206 is deactivated, the first capacitor C_{SB} is discharged, the second signal V₂ decreases, and the threshold of the first comparator 204 is changed to the first threshold Vᵣ₁.

In FIG. 4, the signal generation circuit includes a counter 207. In the configuration, the input end of the counter 207 is connected to the output end of the first comparison circuit, that is, the first comparator 204. The output end of the counter 207 is connected to an input end of the second comparison circuit, that is, the comparison module 205, and outputs a second signal V₂ according to the control signal V_{C}. In the operation, when the feedback signal V_{FB} is greater than the first threshold Vᵣ₁, the count of the counter 207 increases, the second signal V₂ corresponding to the count value output by the counter 207 increases, and the threshold of the first comparator 204 is changed to the second threshold Vᵣ₂; when the feedback signal V_{FB} is less than the second threshold Vᵣ2, the count of the counter 207 is reset, and the second signal V₂ corresponding to the count value output by the counter 207 decreases. In the disclosure, the first threshold Vᵣ₁ is greater than the second threshold Vᵣ₂.

The frequency setting signal generation circuit 2 is connected to the switch control circuit 4 through a switch SW2, and through the channel switching of the switch SW2, the frequency controlling in the light load state and the frequency controlling in the heavy load state are realized. In the heavy load state, SW2 turns on the FB end, and frequency controlling is performed directly according to the feedback signal V_{FB}; in the light load state, SW2 turns on the output end of the frequency setting signal generation circuit 2, and frequency controlling is performed according to the frequency setting signal V_{f} output by the frequency setting signal generation circuit 2. The switching of the switch SW2 may be implemented according to the controlling of the load detection circuit 1. Specifically, the details will be explained in subsequent embodiments.

In practical applications, the semiconductor device may integrate all components of the frequency setting signal generation circuit 2 on the same semiconductor chip 100, alternatively, the semiconductor device may integrate some components of the frequency setting signal generation circuit 2 on the same semiconductor chip 100, and the non-integrated components are connected to the semiconductor chip through specific ends. For example, in FIG. 3, the feedback circuit is not integrated but connected to the semiconductor chip 100 through the FB end; the first capacitor C_{SB} of the signal generation circuit is not integrated but connected to the semiconductor chip 100 through an SB end. In FIG. 4, the feedback circuit is not integrated but connected to the semiconductor chip 100 through the FB end. Compared with FIG. 3, FIG. 4 uses the counter 207 instead of the charge and discharge control part 206 and the first capacitor C_{SB}, which may reduce the quantity of components in the circuit and the quantity of ends of the semiconductor device, but the disclosure is not limited thereto.

Please continue to refer to FIG. 3 and FIG. 4. The load detection circuit 1 includes a load current integration part and a third comparator. The load current integration part is used to integrate the load current flowing through the primary winding P of the transformer T in the current resonant power supply 5 to obtain a first voltage value V_{CL}. In FIG. 3 and FIG. 4, the load current integration part includes a capacitor C4, a resistor R1, a resistor R2, and a capacitor CCL. In the configuration, the capacitor C4 and the resistor R1 are connected in series between an end of the primary winding P and the grounding end; an end of the capacitor CCL is connected in series with the resistor R2 and then connected between the capacitor C4 and the resistor R1, and the other end is grounded. A switch SW1 may be connected in series between the capacitor CCL and the resistor R2, and when the switch SW1 is closed, the load detection circuit 1 detects the load state. The switch SW1 may be controlled by a signal output by the high-voltage side output end of an oscillator 401 mentioned in the subsequent paragraph. For example, when the signal output by the high-voltage side output end is at a high level, the switch SW1 is closed.

In FIG. 3 and FIG. 4, the third comparator 101 is an inverting comparator 101, a non-inverting input end thereof is input with a third threshold Vᵣ₃, and an inverting input end thereof is connected to the capacitor CCL input with a first voltage value V_{CL}. The third comparator 101 is used to determine the load state according to the first voltage value V_{CL} and the preset third threshold Vᵣ₃ and output a signal indicating the load state being the light load state when the first voltage value V_{CL} is less than the third threshold Vᵣ₃.

When the load demand is small, the output voltage V_{OUT} of the current resonant power supply 5 becomes smaller. At this time, the load current in the primary winding P of the transformer decreases, and the first voltage value V_{CL} obtained by integrating the load current with the load current integration part decreases. When the first voltage value V_{CL} is lower than the third threshold Vᵣ₃, a light load state is detected. At this time, the third comparator 101 outputs a high level corresponding to the light load state. The high level controls the switch SW2 to turn on the output end of the frequency setting signal generation circuit 2. When the load demand is large, the output voltage V_{OUT} of the current resonant power supply 5 becomes larger. At this time, the load current in the primary winding P of the transformer increases, and the first voltage value V_{CL} obtained by integrating the load current with the load current integration part increases. When the first voltage value V_{CL} is higher than the third threshold Vᵣ₃, a heavy load state is detected. At this time, a third comparator 208 outputs a low level corresponding to the heavy load state. The low level controls the switch SW2 to turn on the FB end.

In practical applications, the semiconductor device may integrate all components of the load detection circuit 1 on the same semiconductor chip 100, or the semiconductor device may integrate some components of the load detection circuit 1 on the same semiconductor chip 100 and the non-integrated components are connected to the semiconductor chip 100 through specific ends. For example, in FIG. 3 and FIG. 4, the capacitor C4, the resistor R1, and the capacitor CCL are not integrated, and the capacitor C4 and the resistor R1 are connected to the semiconductor chip 100 through a PL end; the capacitor CCL is connected to the semiconductor chip 100 through a CL end. As a result, the quantity of components integrated in the semiconductor chip can be reduced, and the area of the semiconductor chip can be reduced.

Please continue to refer to FIG. 3 and FIG. 4. The burst oscillation circuit 3 includes a fourth comparator 301, which is a non-inverting comparator with a variable threshold. The non-inverting input end of the fourth comparator 301 is connected to the output end of the frequency setting signal generation circuit 2 for inputting the frequency setting signal V_{f}; the inverting input end of the fourth comparator 301 inputs the preset fourth threshold Vᵣ₄ or the preset fifth threshold Vᵣ₅. The burst oscillation circuit 3, that is, the fourth comparator 301, compares the frequency setting signal V_{f} with the preset fourth threshold Vᵣ₄ and the preset fifth threshold Vᵣ₅ respectively, and after the frequency setting signal V_{f} increases to be greater than the fourth threshold Vᵣ₄, and before the frequency setting signal V_{f} decreases to be less than the fifth threshold Vᵣ₅, a burst oscillation start signal is output. Specifically, when the frequency setting signal V_{f} is greater than the fourth threshold Vᵣ₄, the fourth comparator 301 outputs a high level, that is, outputs a burst oscillation start signal, and the threshold of the fourth comparator 301 is changed to the fifth threshold Vᵣ₅; when the frequency setting signal V_{f} is less than the fifth threshold Vᵣ₅, the fourth comparator 301 outputs a low level, that is, stops outputting the burst oscillation start signal, and the threshold of the fourth comparator 301 is changed to the fourth threshold Vᵣ₄. In the disclosure, the fourth threshold Vᵣ₄ is greater than the fifth threshold Vᵣ₅.

In the disclosure, the burst oscillation circuit 3 is connected to a switch driving circuit via an OR logic gate 302. An input end of the OR logic gate 302 is connected to the output end of the burst oscillation circuit 3, that is, the output end of the fourth comparator 301, and the other input end is connected to the output end of the load detection circuit 1, that is, the output end of the third comparator 101 through the NOT logic gate. When a light load state is detected, the third comparator 101 outputs a high level and inputs a low level to the OR logic gate 302 through the connected NOT logic gate. At this time, the output of the OR logic gate 302 depends on the output of the fourth comparator 301. When the fourth comparator 301 outputs a low level, the OR logic gate 302 also outputs a low level. When the fourth comparator 301 outputs a high level, the OR logic gate 302 also outputs a high level.

Please continue to refer to FIG. 3 and FIG. 4. The switch control circuit 4 includes an oscillator, a first driving circuit, and a second driving circuit. The input end of an oscillator 401 is connected to SW2. In the light load state, SW2 turns on the frequency setting signal generation circuit 2 and receives the frequency setting signal V_{f} output by frequency setting signal generation circuit 2, so as to generate a pulse signal controlling the first switching element Q1 and the second switching element Q2 according to the frequency setting signal V_{f} and generate a first driving signal and a second driving signal with opposite levels according to the pulse signal. The oscillator 401 includes a high-voltage side output end and a low-voltage side output end, the high-voltage side output end is connected to the first driving circuit, and outputs the first driving signal to the first driving circuit; the low-voltage side output end is connected to the second driving circuit, and outputs the second driving signal to the second driving circuit.

The first driving circuit includes an AND logic gate 402 and a high-voltage side driver 403, two input ends of the AND logic gate 402 are connected to the high-voltage side output end of the oscillator 401 and the output end of the OR logic gate 302 respectively, the output end of the AND logic gate 402 is connected to the input end of the high-voltage side driver 403, the output end of the high-voltage side driver 403 is connected to the gate of the first switching element Q1.

The second driving circuit includes an AND logic gate 404 and a low-voltage side driver 405, two input ends of the AND logic gate 404 are connected to the low-voltage side output end of the oscillator 401 and the output end of the OR logic gate 302 respectively, the output end of the AND logic gate 404 is connected to the input end of the low-voltage side driver 405, the output end of the low-voltage side driver 405 is connected to the gate of the second switching element Q2.

When the OR logic gate 302 outputs a high level and the first driving signal is also a high level, the AND logic gate 402 outputs a high level, and the high-voltage side driver 403 outputs a driving signal to drive the first switching element Q1 to turn on; at the same time, the second driving signal having opposite levels to the first driving signal is at a low level, the AND logic gate 404 outputs a low level, and the low-voltage side driver 405 does not output a driving signal, that is, the second switching element Q2 turns off. In contrast, when the OR logic gate 302 outputs a high level and the first driving signal is a low level, the AND logic gate 402 outputs a low level, the high-voltage side driver 403 does not output a driving signal, and the first switching element Q1 turns off; at the same time, the second driving signal having opposite levels to the first driving signal is at a high level, the AND logic gate 404 outputs a high level, and the low-voltage side driver 405 outputs a driving signal to drive the second switching element Q2 to turn on. Therefore, under the driving of the first driving signal and the second driving signal, the first switching element Q1 and the second switching element Q2 perform an operation of “alternately turning on and off” in the burst oscillation mode.

The specific structures and operating principles of each circuit of the semiconductor device of the disclosure are described above together with FIG. 3 and FIG. 4. The complete process of controlling the current resonant power supply 5 of the semiconductor device in the light load state will be described through the following examples.

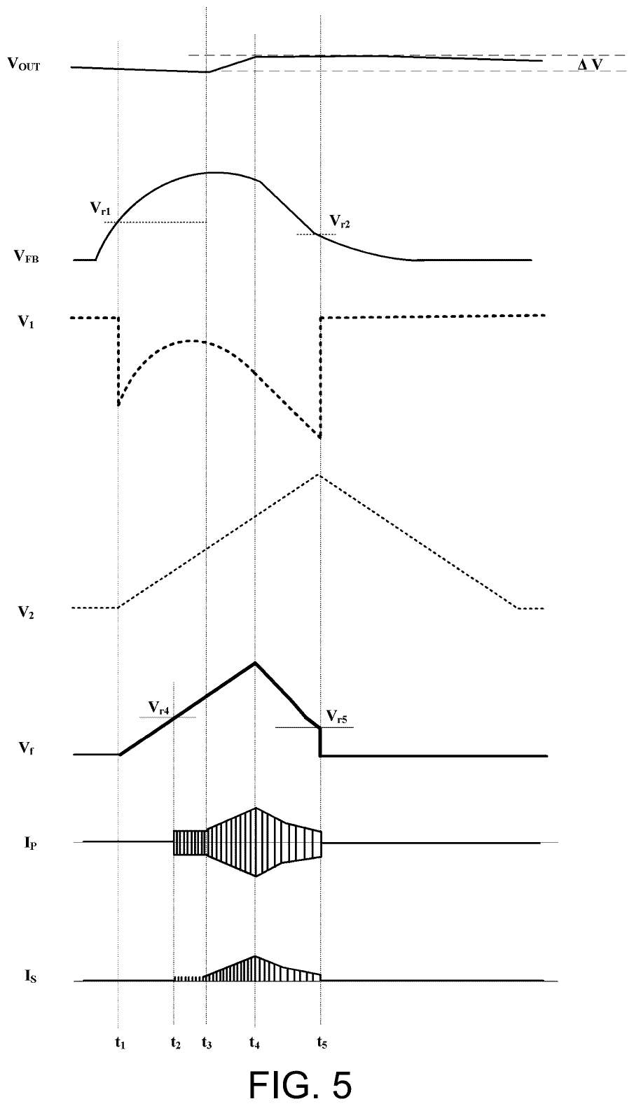

FIG. 5 is a signal timing diagram according to an embodiment of the disclosure, which includes the output voltage V_{OUT} of the current resonant power supply 5, the feedback signal V_{FB} at the FB end, the first signal V₁ after the feedback signal is multiplied by N, the second signal V₂, the frequency setting signal V_{f}, the current signal I_{P} on the primary winding side, and the current signal Is on the secondary winding side, and the vertical dashed lines indicate the same timing.

Please refer to FIG. 3 and FIG. 5 at the same time. Before a timing t1, the output voltage V_{OUT} of the current resonant power supply 5 decreases, and the load current integration part of the load detection circuit 1 integrates the current flowing through the primary winding P of the transformer T, and thus the voltage V_{CL} of the CL end decreases. When V_{CL} is lower than the third threshold Vᵣ₃ (not shown in FIG. 5) input to the third comparator 101, it is determined that the current state is a light load state, and the third comparator 101 outputs a high level corresponding to the light load state. At this time, the switch SW2 turns on the output end of the frequency setting signal generation circuit 2; the input end of the OR logic gate 302 connected to the third comparator 101 inputs a low level, and the output of the OR logic gate 302 completely depends on the output of the fourth comparator 301.

At the same time, as the output voltage V_{OUT} of the current resonant power supply 5 decreases, the feedback signal output by the photoelectric coupler 202, that is, the voltage V_{FB} at the FB end, increases. The N-multiplier circuit 203 outputs a first signal V₁, which is the result of multiplying the feedback signal V_{FB} by the value N.

When the timing t1 is reached, the feedback signal V_{FB} increases to exceed the first threshold Vᵣ₁. At this time, the first comparator 204 outputs a high level and drives the charge and discharge control part 206 to activate to charge the first capacitor C_{SB}, correspondingly, starting from the timing t1, the voltage V_{SB} of the SB end, that is, the second signal V₂ mentioned above, increases. The second comparator 205 compares the first signal V₁ and the second signal V₂ and outputs the smaller signal therebetween as the frequency setting signal V_{f}.

At a timing t2, the frequency setting signal V_{f} exceeds the fourth threshold Vᵣ₄, and the fourth comparator 301 outputs a high level, that is, outputs a burst oscillation start signal. At this time, the OR logic gate 302 also outputs a high level. Therefore, the input ends of the AND logic gate 402 and the AND logic gate 404 connected to the output end of the OR logic gate 302 are input with high level signals. At this time, the outputs of the AND logic gate 402 and the AND logic gate 404 depend on the output of the oscillator 401. The oscillator 401 generates a pulse signal of a set frequency under controlling of the frequency setting signal V_{f}, and generates a first driving signal output through a high-voltage side output end and a second driving signal output through a low-voltage side output end and having opposite levels to the first driving signal according to the pulse signal. When the high-voltage side output end of the oscillator 401 outputs a high level, the AND logic gate 402 outputs a high level, and the high-voltage side driver 403 outputs a driving signal to drive first switching element Q1 to turn on, at the same time, the low-voltage side output end of the oscillator 401 outputs a low level, the AND logic gate 404 outputs a low level, the low-voltage side driver 405 does not output a driving signal, and the second switching element Q2 turns off. In contrast, when the high-voltage side output end of the oscillator 401 outputs a low level, the AND logic gate 402 outputs a low level, the high-voltage side driver 403 does not output a driving signal, and the first switching element Q1 turns off, at the same time, the low-voltage side output end of the oscillator 401 outputs a high level, the AND logic gate 404 outputs a high level, and the low-voltage side driver 405 outputs a driving signal to drive the second switching element Q2 to turn on. At this time, the current resonant power supply 5 operates in a burst oscillation mode.

Before a timing t3, in the burst oscillation mode, the current resonant power supply 5 maintains a nearly stable output; after the timing t3, as the burst oscillation time increases, the output voltage V_{OUT} of the current resonant power supply 5 gradually increases, which is because the first switching element Q1 and the second switching element Q2 of the current resonant power supply 5 are turned on and off alternately. When the first switching element Q1 turns on, the inductor Lr stores energy; when the second switching element Q2 turns on, the energy stored in the inductor Lr maintains the light load demand; as the quantity of times the first switching element Q1 and the second switching element Q2 are alternately turned on and off increases, the energy stored in the inductor Lr gradually increases, so that the output voltage V_{OUT} also gradually increases. Correspondingly, the feedback signal V_{FB} gradually decreases. When the feedback signal V_{FB} decreases to the second threshold Vᵣ₂, that is, when a timing t5 is reached, the first comparator 204 outputs a low level, the charge and discharge control part 206 stops charging the capacitor C_{SB}, and the capacitor C_{SB} starts to discharge, so the voltage of the SB end, that is, the second signal V₂, gradually decreases.

At the timing t5, the frequency setting signal V_{f} decreases to the fifth threshold Vᵣ₅, and the fourth comparator 301 outputs a low level, that is, the burst oscillation start signal is no longer output, at this time, the OR logic gate 302 also outputs a low level, and the input ends of the AND logic gate 402 and the AND logic gate 404 connected to the output end of the OR logic gate 302 are input with low level signals. Therefore, the current resonant power supply 5 stops operating in the burst oscillation mode.

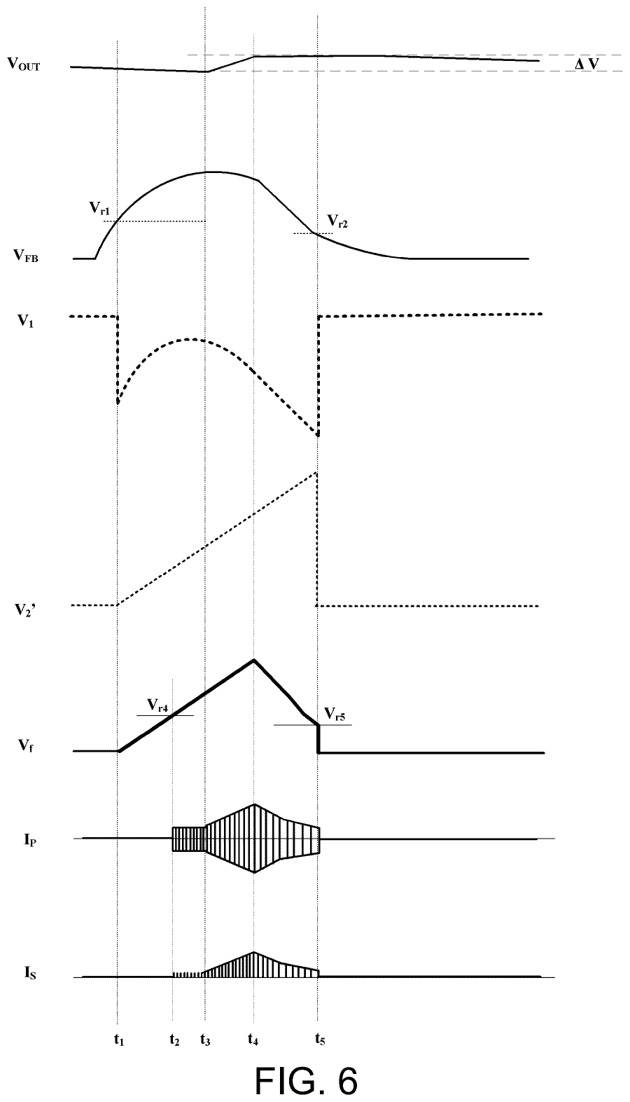

The operating principle of the semiconductor device shown in FIG. 4 is similar to FIG. 3, except that the first signal V₁ is changed from the voltage V_{SB} at the SB end in FIG. 3 to the voltage output by the counter 207 corresponding to the count value thereof, that is, the waveform of the second signal V₂ shown in FIG. 5 is slightly different. Specifically, reference may be made to a second signal V2′ shown in FIG. 6. When the feedback signal V_{FB} decreases to the second threshold Vᵣ₂, the count value of the counter 207 is reset, and the signal corresponding to the count value output by the counter also decreases instantaneously. The rest of the parts are the same as in FIG. 3. Therefore, for the operating principle of FIG. 4, reference may be made to the operating principle of FIG. 3, and details will not be repeated here.

It may be seen that in the light load state, the activating and deactivating of the burst oscillation mode of the current resonant power supply 5 is determined by the frequency setting signal V_{f}. After the frequency setting signal V_{f} increases to exceed the fourth threshold Vᵣ₄, and before decreases to the fifth threshold Vᵣ₅, the current resonant power supply 5 operates in the burst oscillation mode. Therefore, as long as the value of N is reasonably selected, the value of the first signal V₁ (V₁=V_{FB}*N) may be changed, thereby the magnitude relationship between the first signal V₁ and the second signal V₂ is changed, and thereby the timing of the frequency setting signal being decreased to the fifth threshold Vᵣ₅ is changed.

For example, as described above, the second comparator 205 compares the first signal V₁ and the second signal V₂ and outputs the smaller signal as the frequency setting signal V_{f}. In FIG. 5 and FIG. 6, before a timing t4, the second signal V₂ (or the second signal V₂′) is less than the first signal V₁, and the frequency setting signal V_{f} is the second signal V₂ (or the second signal V₂′); at the timing t4, the second signal V₂ (or the second signal V₂′) is equal to the second signal V₁; after the timing t4, the second signal V₂ (or the second signal V₂′) is greater than the first signal V₁, so the frequency setting signal V_{f} is the first signal V₁. When different values of N are taken, the timing t4 of the first signal V₁ and the second signal V₂ (or the second signal V₂′) being equal are also changed accordingly.

In practical applications, the smaller N is, the earlier the timing t4 is, and the earlier the frequency setting signal V_{f} starts to decrease. As a result, the frequency setting signal V_{f} may decrease to below the fifth threshold Vᵣ₅ earlier, thereby the current resonant power supply 5 stops switching in the burst oscillation mode, that is, the first switching element Q1 and the second switching element Q2 stop the operation of “alternately turning on and off” in the burst oscillation mode. However, when the value of N is too small, the switching times are too small, and the burst oscillation period becomes shorter. At this time, the current resonant power supply may not operate in the burst oscillation mode but in a continuous oscillation mode. Therefore, in practical applications, the burst operation may be optimized by appropriately adjusting the value of N.

Therefore, through changing the value of N, the disclosure can flexibly adjust the burst operation according to the load demand on the secondary side of the transformer T. By advancing the deactivation timing of the burst oscillation mode, the quantity of switching times can be reduced, and the presence of reactive power on the primary side of the transformer T that is not sent to the secondary side can be minimized, thereby the reactive power loss is reduced.

In addition, at the timing t3, which is before the timing t4, where the first signal V₁ and the second signal V₂ (or the second signal V₂′) are equal, the output voltage V_{OUT} of the output current resonant power supply 5 gradually increases. During the period from the timing t3 to the timing t4, the output voltage V_{OUT} continues to increase. Therefore, if the value of N is changed so that the timing t4 occurs earlier, it can prevent V_{OUT} from increasing to an excessively high value, thereby an output overshoot (ripple) AV is reduced.

The embodiments are merely illustrative of the embodiments of the disclosure, but the disclosure is not limited thereto, and appropriate modifications may be made based on the embodiments. For example, each of the embodiments may be used alone, or one or more of the embodiments may be combined.

As may be seen from the embodiments, in the semiconductor device, in the light load state, the disclosure generates the first signal and the second signal according to the feedback signal changing oppositely to the output signal of the current resonant power supply, and generates the frequency setting signal according to the first signal and the second signal; in which the first signal is the signal obtained by multiplying the feedback signal by the value N, the second signal is the signal increasing when the feedback signal is greater than the preset first threshold and decreasing when the feedback signal is less than the preset second threshold, and the frequency setting signal is the smaller signal of the first signal and the second signal. Therefore, the disclosure may change the value of N according to the load demand on the secondary side of the transformer T and flexibly adjust the burst operation. Through changing the value of N to advance the deactivation timing of the burst oscillation mode to an earlier time, the quantity of switching times can be reduced, the presence of reactive power on the primary side of the transformer T that is not sent to the secondary side can be minimized, thereby the reactive power loss is reduced, and the output overshoot (ripple) is also reduced.

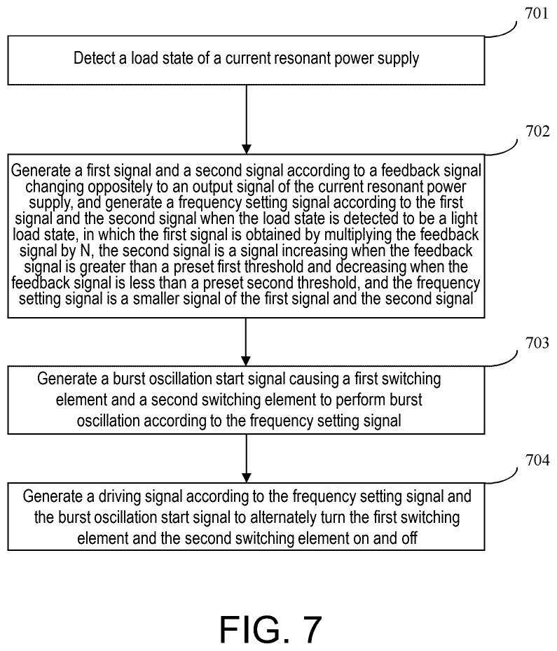

FIG. 7 is a schematic diagram of a control method for the current resonant power supply according to an embodiment of the disclosure. The current resonant power supply controlled by the control method for the current resonant power supply includes a first switching element and a second switching element connected in series between an output end and a grounding end of an AC power source. As shown in FIG. 7, the control method of the current resonant power supply includes:
701, a load state of the current resonant power supply is detected.
702, when the load state is detected as a light load state, a first signal and a second signal are generated according to a feedback signal changing oppositely to the output signal of the current resonant power supply and a frequency setting signal is generated according to the first signal and the second signal; in which the first signal is a signal obtained by multiplying the feedback signal by a value N, the second signal increasing when the feedback signal is greater than a preset first threshold and decreasing when the feedback signal is less than a preset second threshold, and the frequency setting signal is the smaller signal of the first signal and the second signal.
703, a burst oscillation start signal causing the first switching element and the second switching element to perform burst oscillation is generated according to the frequency setting signal.
704, a driving signal is generated according to the frequency setting signal and the burst oscillation start signal to alternately turn the first switching element and the second switching element on and off.

The current resonant power supply control method provided in this embodiment may be implemented based on the semiconductor device of the embodiments of the disclosure and may also be implemented by other devices, and the disclosure is not limited thereto. Since the current resonant power supply control method of this embodiment is similar to the functions of each circuit of the semiconductor device of the embodiments of the disclosure, for the implementation manners, reference may be made to the embodiments mentioned above, so details will not be repeated here.

The disclosure further provides a current resonant power supply, and reference may be made to the overall schematic diagrams shown in FIG. 3 and FIG. 4. The current resonant power supply includes:

The first switching element and the second switching element are connected in series between the output end and the grounding end of the AC power source.

A series circuit is disposed between a connection end and a grounding end of the first switching element and the second switching element.

As described in the embodiments of the disclosure, the semiconductor device controls the first switching element and the second switching element. Regarding the semiconductor device, reference may be made to the description of the embodiments mentioned above of the disclosure, so details will not be repeated here.

The embodiments are merely illustrative of the embodiments of the disclosure, but the disclosure is not limited thereto, and appropriate modifications may be made based on the embodiments. For example, each of the embodiments may be used alone, or one or more of the embodiments may be combined.

The device and method mentioned above in the embodiments of the disclosure may be implemented by hardware, or by a combination of hardware and software. The disclosure relates to such a computer-readable program, which, when the program is executed by a logic component, the logic component is enabled to implement the device or components, or the logic component is enabled to implement the various methods or steps mentioned above. The disclosure further relates to storage media for storing the program, such as a hard disk, a magnetic disk, an optical disk, a DVD, a flash memory.

The method/device described together with the embodiments of the disclosure may be directly embodied as hardware, a software module executed by a processor, or a combination of the above. For example, one or more of the functional block diagrams shown in the drawing and/or one or more combinations of the functional block diagrams may correspond to various software modules of the computer program flow or may correspond to various hardware modules. The software modules may correspond to the steps shown in the drawings respectively. The hardware modules may be implemented by solidifying the software modules using, for example, a field programmable gate array (FPGA).

The software module may be located in RAM memory, flash memory, ROM memory, EPROM memory, EEPROM memory, registers, hard disk, removable disk, CD-ROM, or any other form of storage medium known in the art. A storage medium may be coupled to the processor such that the processor may read information from, and write information to, the storage medium, or may be integrated to the processor. The processor and the storage medium may reside in an ASIC. The software module may be stored in a memory of the mobile end, or may be stored in a memory card that may be inserted into the mobile end. For example, if the device (such as a mobile end) uses a relatively large-capacity MEGA-SIM card or a large-capacity flash memory device, then the software module may be stored in the MEGA-SIM card or the large-capacity flash memory device.

For one or more of the functional blocks and/or one or more combinations of the functional blocks described in the drawings, implementations may be made by adopting a general-purpose processor, a digital signal processor (DSP), an application-specific integrated circuit (ASIC), a field-programmable gate array (FPGA), or other programmable logic device, discrete gate or transistor logic devices, discrete hardware components, or any suitable combinations thereof for performing the functions described in the disclosure. One or more of the functional blocks and/or one or more combinations of the functional blocks described in the drawings may also be implemented as a combination of computing devices, for example, a combination of a DSP and a microprocessor, a plurality of microprocessors, one or more microprocessors in communication with a DSP, or any other such configuration.

The disclosure is described above together with specific implementation methods, but persons skilled in the art should be aware that the descriptions are exemplary and are not intended to limit the scope of protection of the disclosure. Persons skilled in the art may make various variations and modifications to the disclosure based on the spirit and principles of the disclosure, and the variations and modifications are also within the scope of the disclosure.

What is claimed is:

1. A semiconductor device configured to control a current resonant power supply, wherein the current resonant power supply comprises a first switching element and a second switching element connected in series between an output end and a grounding end of an AC power source, and the semiconductor device comprises:
a load detection circuit configured to detect a load state of the current resonant power supply;
a frequency setting signal generation circuit generating a first signal and a second signal according to a feedback signal changing oppositely to an output signal of the current resonant power supply and generating a frequency setting signal according to the first signal and the second signal in response to the load detection circuit detecting the load state being a light load state, wherein the first signal is a signal obtained by multiplying the feedback signal by a value N, the second signal is a signal increasing in response to the feedback signal being greater than a first threshold preset and decreasing in response to the feedback signal being less than a second threshold preset, and the frequency setting signal is a smaller signal of the first signal and the second signal;
a burst oscillation circuit generating a burst oscillation start signal causing the first switching element and the second switching element to perform burst oscillation according to the frequency setting signal; and
a switch control circuit generating a driving signal according to the frequency setting signal and the burst oscillation start signal to alternately turn the first switching element and the second switching element on and off.

2. The semiconductor device according to claim 1, wherein the frequency setting signal generation circuit comprises:
a photoelectric coupler generating the feedback signal according to the output signal of the current resonant power supply;
an N-multiplier circuit multiplying the feedback signal by the value N to obtain the first signal;
a first comparison circuit configured to generate a control signal according to the feedback signal, the first threshold, and the second threshold;
a signal generation circuit generating the second signal according to the control signal; and
a second comparison circuit comparing the first signal and the second signal and outputting a smaller signal of the first signal and the second signal as the frequency setting signal.

3. The semiconductor device according to claim 2, wherein the signal generation circuit comprises:
a charge and discharge control part, wherein an input end of the charge and discharge control part is connected to an output end of the first comparison circuit, and the charge and discharge control part is activated or deactivated according to the control signal; and
a first capacitor, wherein an end of the first capacitor is connected to an output end of the charge and discharge control part and an input end of the second comparison circuit, the other end of the first capacitor is connected to the grounding end, and the first capacitor outputs the second signal to the second comparison circuit,
wherein in response to the feedback signal being greater than the first threshold, the charge and discharge control part is activated, the first capacitor is charged, and the second signal increases; in response to the feedback signal being less than the second threshold, the charge and discharge control part is deactivated, the first capacitor is discharged, and the second signal decreases.

4. The semiconductor device according to claim 2, wherein the signal generation circuit comprises:
a counter, wherein an input end of the counter is connected to an output end of the first comparison circuit, an output end of the counter is connected to an input end of the second comparison circuit, and the counter outputs the second signal according to the control signal,
wherein in response to the feedback signal being greater than the first threshold, a count of the counter increases and the second signal increases; in response to the feedback signal being less than the second threshold, the count of the counter is reset and the second signal decreases.

5. The semiconductor device according to claim 1, wherein the load detection circuit comprises:
a load current integration part integrating a load current flowing through the current resonant power supply to obtain a first voltage value; and
a third comparator determining the load state according to the first voltage value and a third threshold preset and outputting a signal indicating the load state being the light load state in response to the first voltage value being less than the third threshold.

6. The semiconductor device according to claim 1, wherein the burst oscillation circuit comprises:
a fourth comparator comparing the frequency setting signal with a fourth threshold preset and a fifth threshold preset respectively and outputting the burst oscillation start signal after the frequency setting signal increases to be greater than the fourth threshold and before the frequency setting signal decreases to be less than the fifth threshold.

7. The semiconductor device according to claim 1, wherein the switch control circuit comprises:
an oscillator generating a pulse signal controlling the first switching element and the second switching element according to the frequency setting signal;
a first driving circuit generating a first driving signal according to the pulse signal and the burst oscillation start signal and sending the first driving signal to the first switching element;
a second driving circuit generating a second driving signal according to the pulse signal and the burst oscillation start signal and sending the second driving signal to the second switching element,
wherein under the driving of the first driving signal and the second driving signal, the first switching element and the second switching element are turned on and off alternately.

8. The semiconductor device according to claim 1, wherein the value N is a positive number greater than 1.

9. A control method for a current resonant power supply, wherein the current resonant power supply comprises a first switching element and a second switching element connected in series between an output end and a grounding end of an AC power source, and the method comprises:
detecting a load state of the current resonant power supply;
in response to the load state being detected as a light load state, generating a first signal and a second signal according to a feedback signal changing oppositely to an output signal of the current resonant power supply and generating a frequency setting signal according to the first signal and the second signal; wherein the first signal is a signal obtained by multiplying the feedback signal by a value N, the second signal is a signal increasing in response to the feedback signal being greater than a first threshold preset and decreasing in response to the feedback signal being less than a second threshold preset, and the frequency setting signal is a smaller signal of the first signal and the second signal;
generating a burst oscillation start signal causing the first switching element and the second switching element to perform burst oscillation according to the frequency setting signal; and
generating a driving signal according to the frequency setting signal and the burst oscillation start signal to alternately turn the first switching element and the second switching element on and off.

10. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 1, wherein the semiconductor device controls the first switching element and the second switching element.

11. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 2, wherein the semiconductor device controls the first switching element and the second switching element.

12. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 3, wherein the semiconductor device controls the first switching element and the second switching element.

13. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 4, wherein the semiconductor device controls the first switching element and the second switching element.

14. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 5, wherein the semiconductor device controls the first switching element and the second switching element.

15. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 6, wherein the semiconductor device controls the first switching element and the second switching element.

16. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 7, wherein the semiconductor device controls the first switching element and the second switching element.

17. A current resonant power supply, comprising:
a first switching element and a second switching element connected in series between an output end and a grounding end of an AC power source;
a series circuit disposed between a connection end and a grounding end of the first switching element and the second switching element; and
the semiconductor device according to claim 8, wherein the semiconductor device controls the first switching element and the second switching element.
